(19) United States
(12) Patent Application Publication
(10) Pub. No.: US 2003/0077220 A1
(43) Pub. Date: Apr. 24, 2003

(54) Method for making alumina

(76) Inventors: De-Yin Jeng, Oak Park, CA (US); Tatsuo Sunayama, Susono-city (JP); Takayuki Suzuki, Camarillo, CA (US); Chorng-Jeou Chen, Westlake Village, CA (US)

Correspondence Address: Sheppard, Mullin, Richter & Hampton LLP, 333 South Hope Street, 48th Floor, Los Angeles, CA, 90071, US

(21) Appl. No.: 09/938,813

(22) Filed: Aug. 24, 2001

(51) Int. Cl. C01F 7/24

(52) U.S. Cl. 423/625; 423/626

(57) ABSTRACT

A method for making γ-alumina includes drying wet alumina gels at temperatures and pressure below those commonly present in preparation of γ-alumina. The method allows for production of γ-alumina with greater ease of production and controllability of physical properties than known methods. Alumina produced using this method has high surface area and porosity and is highly suitable for making γ-alumina powders for use as catalyst supports.

### BACKGROUND OF THE INVENTION

This invention relates generally to a method for making alumina and, more particularly, to an improved method for making alumina having high surface area and porosity.

Transition alumina, i.e., aluminum oxide (Al₂O₃), is used as a catalyst support and for various adsorption applications. Specifically, gamma-alumina (γ-alumina), a transition alumina, is a widely used oxide catalyst support, due to its high surface area, high porosity, and good thermal stability. Transition alumina also has a high melting point—greater than 2000° C.—making it particularly suitable for use as a catalyst support. This high melting point allows particles of a finely divided catalytic material to be separated from one another in such a way that they will be prevented from agglomerating or coalescing.

Transition alumina can be prepared using a number of different chemical processes. Transition alumina powder is conventionally produced using Bayer's process, in which alumina hydroxide is thermally decomposed in an air flow at elevated temperatures. Another commonly used method is the acid-base approach to synthesize the transition alumina starting from an aqueous acidic solution (e.g., an alumina sulphate solution). Precipitation occurs when the pH of the solution is increased to greater than 3 by addition of a base. By varying the pH and temperature of the solution, the precipitated gel-like substance can be produced as either an amorphous material or as a crystalline form of Al(OH)₃, which can be further converted into the γ-alumina phase by subsequent firing at appropriate temperatures. One disadvantage of these methods, however, is in the strong interaction between the freshly precipitated alumina gels and the ions from the precursor solutions. This interaction makes preparation of alumina in a relatively pure form difficult.

Japanese patent Kokoku Publication No. 16934/1967 describes a method for the production of transition alumina in which an alumina sulfate is thermally decomposed. U.S. Pat. No. 5,508,016 to Yamanichi et al. discloses a method for producing transition alumina having larger surface area, in which an alumina sulfate is thermally decomposed under a particular atmosphere at relatively low temperatures. A major disadvantage of the sulfate approach described in these references is the hazardous sulfur dioxide gas produced during the decomposition process.

Another chemical route used to prepare alumina is via the hydrolysis of aluminum alkoxides. Aluminum alkoxides are mild in their reactivity, and their hydrolysis is easier to control than that of sulfates. The publication Yoldas, B. E., J. Mat. Sci., 10 (1975) 1856-1860, describes a method in which the sol obtained after acid peptization of the hydrolysis product is gelled by removing part of the liquid phase, or by adding a suitable electrolyte that neutralizes the positive surface charge of the colloidal particles. The publication Teichner, S. J., Nicolaon, G. A. et al., Adv. Collod. Interf. Sci., 5 (1976) 245-273, discloses that the pore structure of the gels produced can be modified by controlling the liquid-vapor interface inside the pores during evaporation. This approach produced aerogels having high surface areas by extracting the liquid under supercritical conditions to avoid the formation of an interface. The publication Mizushima, Y., and Hori, M., J. Non-crystalline Solids, 167 (1994) 1-8, discusses the properties of alumina aerogels prepared under the supercritical conditions of a carbon dioxide and ethanol mixture in a CO₂ extractor at 80° C. and 15.7 MPa. The Mizushima publication describes another method of preparing dry alumina gel under the supercritical condition of ethanol itself in an autoclave at 270° C. and 26.5 MPa. The publication Janosovits, U., Ziegler, G. et al., J. Non-crystalline Solids, 210 (1997) 1-13, discloses preparation of dry alumina aerogels using supercritical drying with CO₂ under 20° C. and 10 MPa. The publication Dong Jin Suh, et al., Chem. Materials, vol. 9, no. 9, (1997) 1903-1905, discloses a synthesis route for preparing high surface area alumina aerogels using supercritical drying of the wet gels with CO₂ at 60° C. and 24 MPa.

The above mentioned sol-gel methods, while capable of producing aerogels having various surface area characteristics, require either high temperature or high pressure under supercritical conditions. In the case of the methods discussed incorporating supercritical drying with CO₂, even though the temperature is much reduced, the processing pressure remains high, ranging from 15.7 to 24 MPa.

Accordingly, there exists a need for a method that produces relatively pure alumina having a controllable range of surface area and using only moderate temperature and pressure. The present invention satisfies these and other needs, and provides further related advantages.

### SUMMARY OF THE INVENTION

The present invention resides in a method for making γ-alumina, comprising: preparing a solution including aluminum alkoxide and water; drying the solution to form a gel; performing a number of solvent exchanges using a first solvent on the gel to remove water from the gel; adding a second solvent to the gel; heating the gel to a temperature of about 220° C. or less at a pressure of about 3.5 MPa or less; and heating the gel to a temperature of about 600° C. or greater to effect calcination of the gel.

After addition of a second solvent, the gel preferably is heated to a temperature between about 140° C. and about 220° C. at a pressure between about 0.67 MPa and about 3.5 MPa. To effect calcination, the gel preferably is heated to a temperature of between about 600° C. and about 1,000° C. The preferred number of solvent exchanges is a number sufficient to reduce the water content of the gel to less than about 1 percent by weight, preferably three. The solvent exchanges preferably are performed at a temperature of about 45° C.

The γ-alumina produced preferably has a surface area between about 154 m²/g and about 336 m²/g and an average pore radius between about 7.56 nm and about 17.2 nm.

The present invention also resides in a method for making γ-alumina comprising: preparing a solution comprising aluminum sec-butoxide and water; refluxing the solution for about two hours at a temperature of about 90° C.; performing peptization on the solution using HNO₃; refluxing the solution for about 22 hours at a temperature of about 90° C.; boiling the solution at a temperature between about 105° C. and about 110° C. for about four hours; casting the solution into a mold; holding the solution in the mold at a temperature of about 25° C. for about 144 hours to form a gel; performing a solvent exchange on the gel about every 24 hours for three times at about 45° C. using acetone; drying the gel in isopropanol at a temperature of 220° C. at a pressure between about 3.2 MPa and about 3.5 MPa for about 8 hours; and heating the gel to a temperature of about 800° C. for about six hours under air flowing at about 1 liter per minute to effect calcination of the gel.

Other features and advantages of the present invention should become apparent from the following detailed description of the invention, taken with the accompanying drawings, which illustrate the principles of the invention.

### BRIEF DESCRIPTION OF THE DRAWINGS

FIG. 1 is a graphical representation of the relationship between the calcination temperature and surface area of powders produced using the method of the present invention at drying temperatures of 140° C. and 220° C.

FIG. 2 is a graphical representation of the relationship between the calcination temperature and pore radius of powders produced using the method of the present invention at drying temperatures of 140° C. and 220° C.

FIG. 3 is a graphical representation of the relationship between the calcination temperature and pore volume of powders produced using the method of the present invention at drying temperatures of 140° C. and 220° C.

FIG. 4 is a graphical representation of the relationship between the MPD drying temperature and surface area of powders produced using the method of the present invention using either acetone or isopropanol (IPA) as the second solvent added to the gel.

FIG. 5 is a graphical representation of the relationship between the water content and surface area of powders produced using the method of the present invention.

### DETAILED DESCRIPTION OF THE PREFERRED METHODS

The present invention resides in an alumina sol-gel method and a subcritical drying method in which aerogels can be prepared at reduced temperature and pressure. The present invention allows for operating pressures of less than 3.5 MPa and operating temperatures less than 220° C. Table 1 compares two sample operating temperature and pressures used in the current sub-critical drying method versus the supercritical drying methods using CO₂ or ethanol, as known in the prior art. As Table 1 indicates, the present invention allows for a pressure that is approximately 15% or less of that used in prior art methods.

TABLE 1
Comparison of Operating Temperature and Pressure for
Present Invention and Prior Art

| Process | Drying Liquid | Temperature (° C.) | Pressure (MPa) |
|---|---|---|---|
| Prior Art #1 | CO₂ | 80 | 15.7 |
| Prior Art #2 | CO₂ | 60 | 24.0 |
| Prior Art #3 | Ethanol | 270 | 26.5 |
| Present | Isopropanol | 220 | <3.6 |
| Invention #1 | | | |
| Present | Isopropanol | 140 | <1.0 |
| Invention #2 | | | |

Furthermore, in the present invention, the solvent exchange takes place at a temperature of 45° C., rather than the 20° C. generally practiced. This higher exchange temperature results in a more complete removal of water content from the gel, thus leading to a higher surface area for the resultant powder.

In the present invention, wet alumina gels are dried under sub-critical conditions, referred to as moderate pressure drying, or MPD. Specifically, the gels are dried in iso-propanol at a temperature of from about 140° C. to about 240° C., under a pressure of about 0.67 to about 3.5 MPa in an autoclave. High surface area (i.e., 200 to 300 m²/g) γ-alumina powders can be fabricated by calcining the moderate pressure-dried alumina gels at 600 to 1,000° C., more preferably at 700 to 900° C., for 6 hours. The average pore radius of the y-alumina gel produced ranges from about 7.5 nm to 17.2 nm. The low density aerogel can then be more readily ball-milled to different particle sizes ranging from 5 μm to approximately 0.2 μm, because the lower density implies a gel that can be more readily crushed.

Additionally, the significantly lower temperature and pressure of the sub-critical condition, the reduced environmental hazard (due to no production of sulfur by-products), and the relatively high-purity alumina phase produced all lead to both lower production cost and greater operational safety using the method of the present invention. As is discussed below, the method of the present invention allows for tailoring of the gel microstructures to produce powders having different surface areas and pore sizes, by varying the number of solvent exchange cycles, and by choosing the MPD drying temperatures and pressures. An additional advantage of the MPD method is that it produces dried powder which can, after calcination, easily be milled to less than 1 micron-sized particles.

The method of the invention will be better understood by reference to the following examples.

### EXAMPLES

The method of the present invention was used to prepare y-alumina powder having surface area greater than 200 m²/g. Procedures as described in U.S. Pat. Nos. 3,941,719 and 3,944,658 to Yoldas were used to prepare a boehmite sol as a precursor to the final product. The materials used were 180 grams of aluminum sec-butoxide (95 wt. %) and 500 mL of deionized water resulting in a molar ratio of 1:40 of aluminum to water. These were combined and the mixture was refluxed for two hours at 90° C. Next, peptization by HNO₃ was performed using a molar ratio of 0.07:1 of HNO₃:Al and refluxed for 22 hours at 90° C. to form the sol.

This sol then was boiled at a temperature ranging from about 105° C. to about 110° C. for four hours to form a viscous solution. The solution was cast into a polymethylpentene mold and allowed to gel at room temperature in open air for about 144 hours. Next, solvent exchange was conducted at 45° C. using acetone as the solvent. Alternately, isopropanol can be used as a solvent, and the temperature preferably is 45° C. After 24 hours, the solvent was decanted and fresh acetone was placed in the mold. This was repeated two more times to thoroughly replace the water in the gel with acetone.

Next, MPD procedures were used to dry the gel. Isopropanol was used as the solvent, and the gel was immersed in this solution to form a gel-solvent mixture. The mixture was heated from 25° C. to about 220° C. in 7 hours. The mixture was held at 220° C. for eight hours at a pressure ranging from 470 to 506 psi (approximately 3.24 to 3.49 MPa). The pressure was 0.67 MPa at 140° C. and reached a maximum of 3.60 MPa at about 220° C. Calcination for γ-phase formation was performed using known methods at 800° C. for 6 hours under air flowing at 1 liter per minute. After MPD drying, the as-dried gel was a dark brownish to black color. After calcination at 800° C. as described above, the color of the gel was white.

The following examples show how variations within the scope of the present invention can be used to control the surface area and the pore size of the gels formed.

1. Effect of MPD Drying Temperature and Calcination Temperature on the Microstructure of γ-Alumina Powders

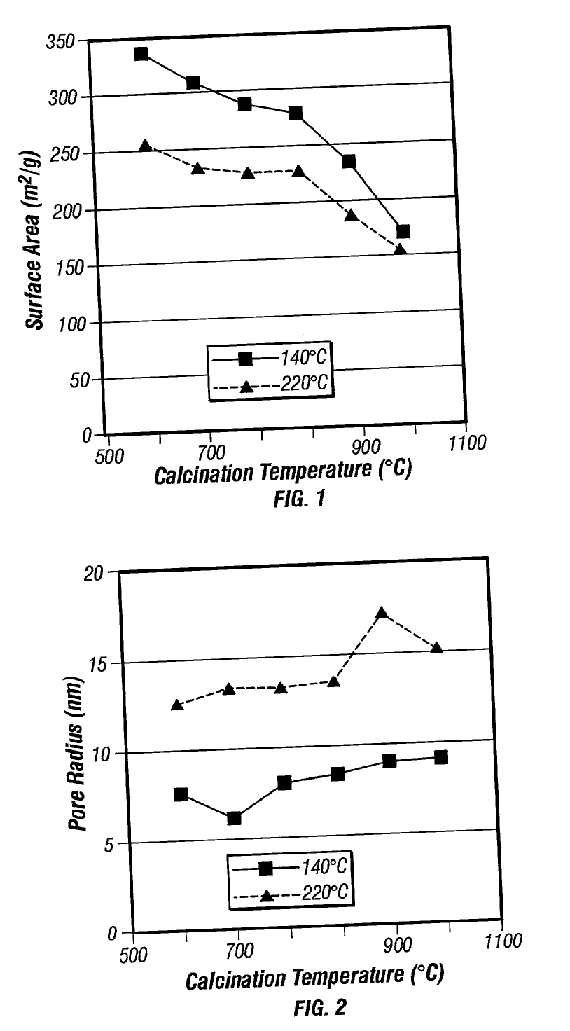

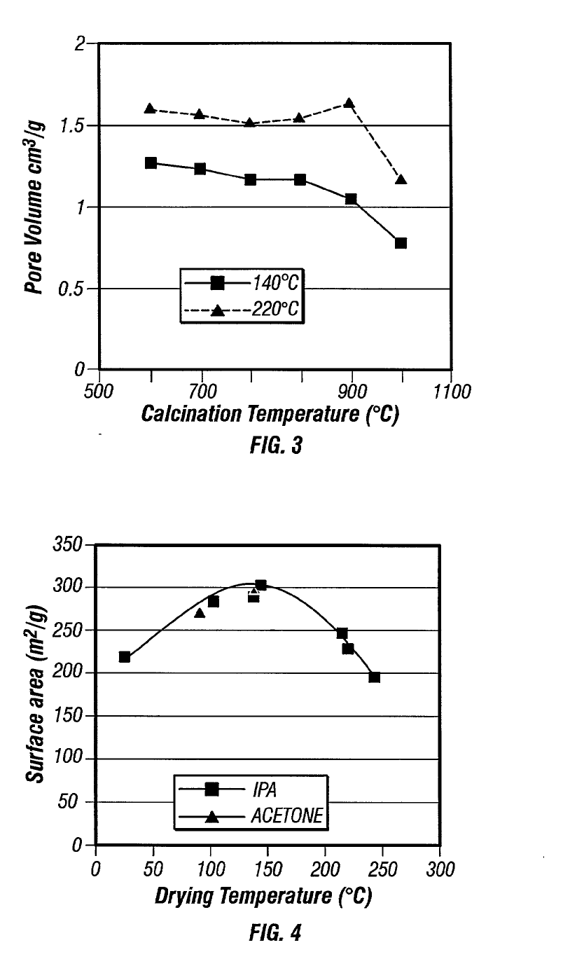

The surface area, pore radius, and pore volume of the powders prepared by MPD drying at both 140° C. and at 220° C. are shown in Table 2. The as-dried powders were calcined at 600° C., 700° C., 750° C., 800° C., 900° C. and 1,000° C. for 6 hours. As the data indicate, a wide range of surface area can be achieved by varying calcination temperature, while the pore radius increases only slightly. The pore volume of the calcined powders showed a decreasing trend with increasing temperatures. These data are illustrated in FIGS. 1, 2, and 3.

TABLE 2
Surface area, pore radius, and pore volume of
calcined γ-alumina powders

| | | | | | Pore Volume | |
|---|---|---|---|---|---|---|
| Calcina- | Surface Area (m²/g) | | Pore Radius (nm) | | (cm³/g) | |
| tion | MPD Temperature | | MPD Temperature | | MPD Temperature | |
| Temp. | (° C.) | | (° C.) | | (° C.) | |
| (° C.) | 140 | 220 | 140 | 220 | 140 | 220 |
| 600 | 336.46 | 255.07 | 7.559 | 12.541 | 1.27 | 1.60 |
| 700 | 307.20 | 235.95 | 6.143 | 13.337 | 1.23 | 1.57 |
| 750 | 289.45 | 229.75 | 7.982 | 13.242 | 1.16 | 1.52 |
| 800 | 279.59 | 228.00 | 8.280 | 13.498 | 1.16 | 1.54 |
| 900 | 233.24 | 189.57 | 8.949 | 17.193 | 1.04 | 1.63 |
| 1,000 | 172.56 | 154.26 | 9.022 | 15.106 | 0.78 | 1.17 |

2. Effect of MPD Temperature on Surface Area of γ-Alumina Powders

The relationship of the surface area with the MPD drying temperature was evaluated. Two different solvents, isopropanol and acetone, were used for the solvent exchange step to compare their effect on the surface area of the resulting product. MPD drying temperatures were chosen to be 25° C., 100° C., 140° C., 220° C., and 240° C. All of the as-dried alumina gels produced at these drying temperatures were calcined at 750° C. for 6 hours using the air flow described above, and the resulting surface areas were measured. These data are shown in FIG. 4. The surface area of the γ-alumina is highest at a MPD drying temperature of about 140° C. Surface area decreased as drying temperature decreased or increased from 140° C. In addition, no substantial difference in surface area was observed from using isopropanol instead of acetone for solvent exchange.

3. Effect of Water Content on the Surface Area of the Calcined γ-Alumina Powders

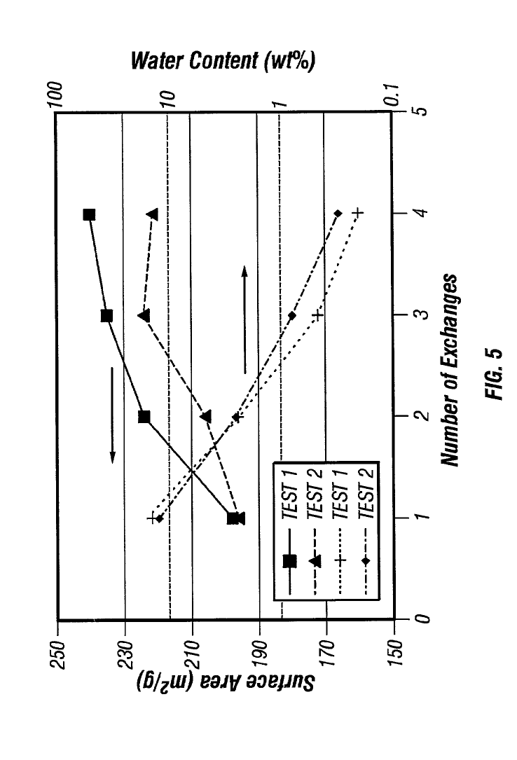

The relationships between surface area and the number of solvent exchange cycles was measured, and the resulting data are shown in FIG. 5. Surface area increases and water content in the solvent decreases exponentially as the number of solvent exchange cycles is increased, up to three solvent exchanges, at which point the surface area leveled off. The water content after three solvent exchanges was less than 1 percent by weight. On the other hand, pore radius and pore volume did not change with increased solvent exchanges. From these results, it is observed that three solvent exchange cycles are necessary and sufficient for maximum possible surface area.

As demonstrated above, the present invention allows for production of γ-alumina under conditions easier and safer than those previously known. The present invention also allows for tailoring of the y-alumina produced by varying the process conditions.

Although the invention has been disclosed in detail with reference only to the preferred method, those skilled in the art will appreciate that additional methods for making alumina are within the scope of the invention. Accordingly, the invention is defined only by the following claims.

We claim:

1. A method for making y-alumina comprising:
preparing a solution including aluminum alkoxide and water;
drying the solution to form a gel;
performing a number of solvent exchanges using a first solvent on the gel to remove water from the gel;
adding a second solvent to the gel;
heating the gel to a temperature of about 220° C. or less at a pressure of about 3.5 MPa or less; and
heating the gel to a temperature of about 600° C. or greater to effect calcination of the gel.

2. A method as defined in claim 1, wherein heating the gel to a temperature of about 220° C. or less at a pressure of about 3.5 MPa or less comprises heating the gel to a temperature between about 140° C. and about 220° C.

3. A method as defined in claim 1, wherein heating the gel to a temperature of about 220° C. or less at a pressure of about 3.5 MPa or less comprises heating the gel at a pressure between about 0.67 MPa and about 3.5 MPa.

4. A method as defined in claim 1, wherein heating the gel to a temperature of about 600° C. or greater comprises heating the gel to a temperature between about 600° C. and about 1,000° C.

5. A method as defined in claim 1, wherein the number of solvent exchanges performed is a number sufficient to reduce the water content of the gel to less than about 1 percent by weight.

6. A method as defined in claim 5, wherein the number of solvent exchanges performed is three.

7. A method as defined in claim 1, wherein the solvent exchanges are performed at a temperature of about 45° C.

8. A method as defined in claim 1, wherein the y-alumina has a surface area between about 154 m²/g and about 336 m²/g.

9. A method as defined in claim 1, wherein the y-alumina has an average pore radius between about 7.56 nm and about 17.2 nm.

10. A method for making y-alumina comprising:
preparing a solution comprising aluminum sec-butoxide, and water;
refluxing the solution for about two hours at a temperature of about 90° C.;
performing peptization on the solution using HNO₃;
refluxing the solution for about 22 hours at a temperature of about 90° C.;
boiling the solution at a temperature between about 105° C. and about 110° C. for about four hours;
casting the solution into a mold;
holding the solution in the mold at a temperature of about 25° C. for about 144 hours to form a gel;
performing a solvent exchange on the gel about every 24 hours for three times at about 45° C. using acetone;
drying the gel in isopropanol at a temperature of 220° C. at a pressure between about 3.2 MPa and about 3.5 MPa for about 8 hours; and
heating the gel to a temperature of about 800° C. for about six hours under air flowing at about 1 liter per minute to effect calcination of the gel.
